(19) United States
(12) Patent Application Publication
(10) Pub. No.: US 2018/0266178 A1
(43) Pub. Date: Sep. 20, 2018

(54) Ladder Stabilization System

(71) Applicant: Edward Sapp, Dayton, KY (US)

(72) Inventor: Edward Sapp, Dayton, KY (US)

(21) Appl. No.: 15/459,340

(22) Filed: Mar. 15, 2017

(51) Int. Cl. E06C 7/42

(52) U.S. Cl. CPC E06C 7/423

(57) ABSTRACT

A ladder stabilization system includes a ladder that has a pair of legs and a plurality of rungs extending between the legs. The ladder is selectively positioned at an angle between a horizontal support surface and a vertical support surface. A first stabilizer is removably coupled to the ladder and the first stabilizer extends between the ladder and the horizontal support surface. The first stabilizer extends downwardly from opposite sides of the ladder to inhibit the ladder from tipping laterally on the horizontal support surface. A second stabilizer is removably coupled to the ladder and the second stabilizer extends between the ladder and the vertical support surface. The second stabilizer is horizontally oriented to inhibit the ladder from bouncing on the vertical support surface when the ladder is climbed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to stabilization devices and more particularly pertains to a new stabilization device for stabilizing a ladder for climbing.

### BRIEF SUMMARY OF THE INVENTION

An embodiment of the disclosure meets the needs presented above by generally comprising a ladder that has a pair of legs and a plurality of rungs extending between the legs. The ladder is selectively positioned at an angle between a horizontal support surface and a vertical support surface. A first stabilizer is removably coupled to the ladder and the first stabilizer extends between the ladder and the horizontal support surface. The first stabilizer extends downwardly from opposite sides of the ladder to inhibit the ladder from tipping laterally on the horizontal support surface. A second stabilizer is removably coupled to the ladder and the second stabilizer extends between the ladder and the vertical support surface. The second stabilizer is horizontally oriented to inhibit the ladder from bouncing on the vertical support surface when the ladder is climbed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a first stabilizer and a second stabilizer of a ladder stabilization system according to an embodiment of the disclosure.

FIG. 2 is a right side view of first stabilizer of an embodiment of the disclosure.

FIG. 3 is a front phantom view of an embodiment of the disclosure.

FIG. 4 is a perspective in-use view of an embodiment of the disclosure.

FIG. 5 is a bottom perspective view of an embodiment of the disclosure.

### DETAILED DESCRIPTION OF THE INVENTION

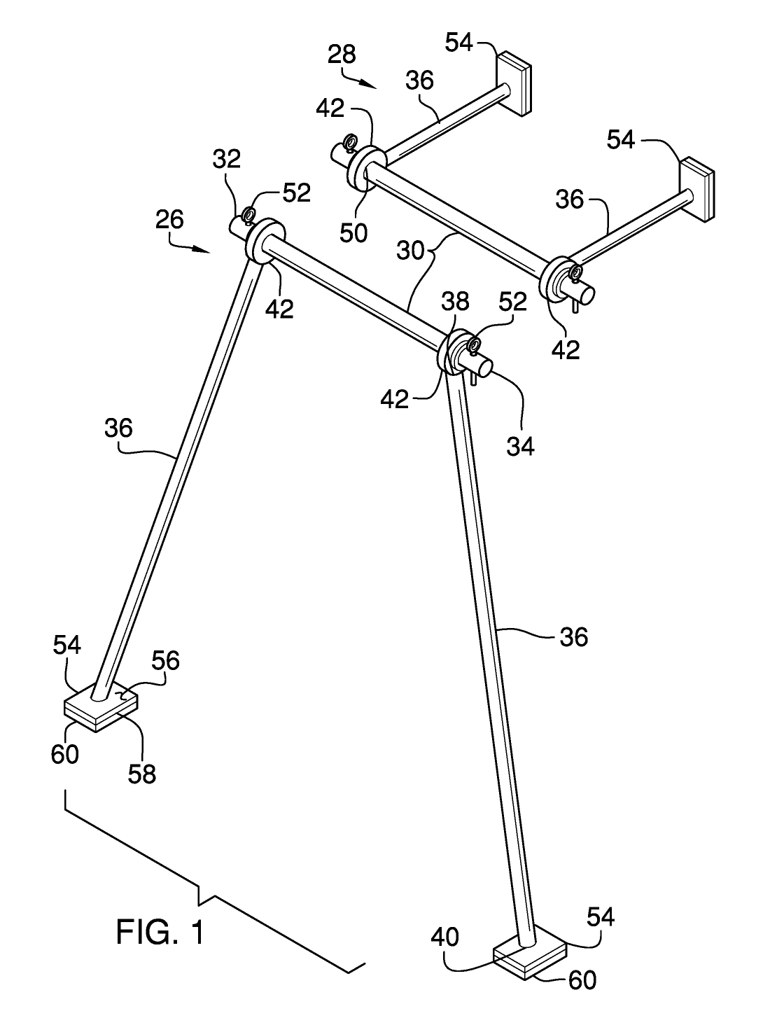

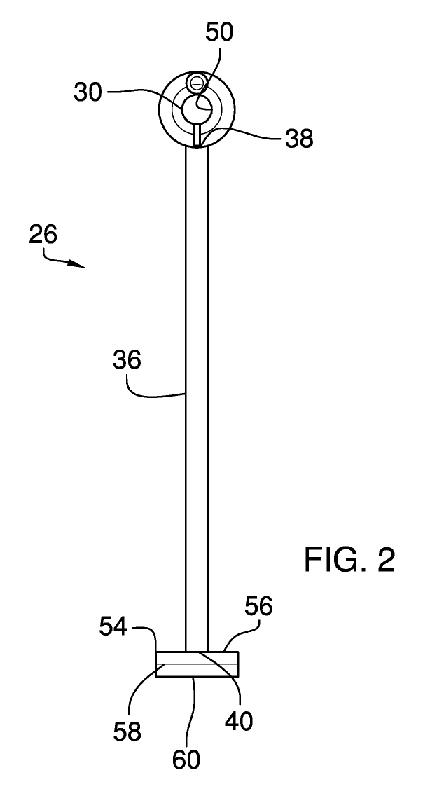

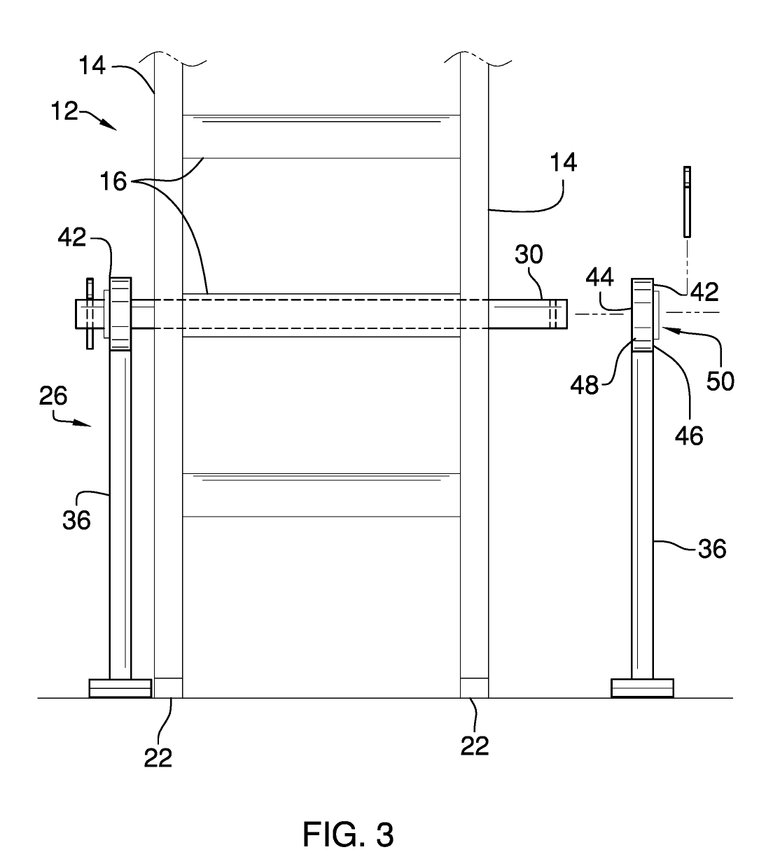

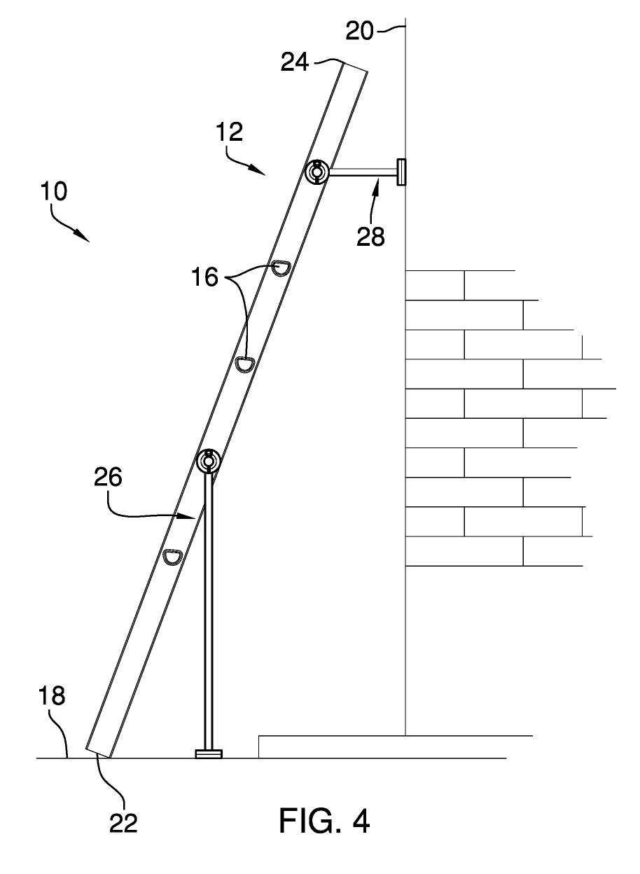

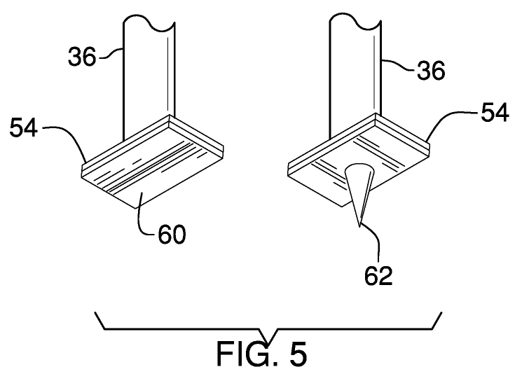

With reference now to the drawings, and in particular to FIGS. 1 through 5 thereof, a new stabilization device embodying the principles and concepts of an embodiment of the disclosure and generally designated by the reference numeral 10 will be described.

As best illustrated in FIGS. 1 through 5, the ladder stabilization system 10 generally comprises a ladder 12. The ladder 12 has a pair of legs 14 and a plurality of rungs 16 extending between the legs 14. Each of the rungs 16 is substantially hollow. The ladder 12 is selectively positioned at an angle between a horizontal support surface 18 and a vertical support surface 20. The horizontal support surface 18 may be a floor or ground and the vertical support surface 20 may be a wall. Each of the legs 14 has a bottom end 22 and a top end 24. The bottom end 22 abuts the horizontal support surface 18 and the top end 24 abuts the vertical support surface 20. The ladder 12 may be an aluminum ladder 12 of any conventional design to include, but not be limited to, extension ladder s and straight ladders.

A first stabilizer 26 is provided and the first stabilizer 26 is removably coupled to the ladder 12. The first stabilizer 26 extends between the ladder 12 and the horizontal support surface 18. Moreover, the first stabilizer 26 extends downwardly from opposite sides of the ladder 12. In this way the first stabilizer 26 inhibits the ladder 12 from tipping laterally on the horizontal support surface 18.

A second stabilizer 28 is provided and the second stabilizer 28 is removably coupled to the ladder 12. The second stabilizer 28 extends between the ladder 12 and the vertical support surface 20. Moreover, the second stabilizer 28 is horizontally oriented. In this way the second stabilizer 28 inhibits the ladder 12 from bouncing on the vertical support surface 20 when the ladder 12 is climbed.

Each of the first 26 and second 28 stabilizers comprises a rod 30 that has a first end 32 and a second end 34. The rod 30 is removably inserted through a selected one of the rungs 16 in the ladder 12 and the rod 30 extends outwardly through each of the legs 14. The rod 30 corresponding to the first stabilizer 26 is positioned closer to the bottom end 22 of the ladder 12 than the top end 24 of the ladder 12. The rod 30 corresponding to the second stabilizer 28 is positioned closer to the top end 24 than the bottom end 22.

A pair of legs 36 is provided and each of the legs 36 has a primary end 38 and a secondary end 40. Each of the legs corresponding to the first stabilizer 26 may have a length ranging between 60.0 cm and 90.0 cm. Each of the legs corresponding to the second stabilizer 28 may have a length ranging between 30.0 cm and 60.0 cm. Each of the first 26 and second 28 stabilizers includes a pair of disks 42. Each of the disks 42 has a first surface 44, a second surface 46 and a peripheral edge 48 extending therebetween. Each of the disks 42 has an opening 50 extending through the first surface 44 and the second surface 46.

The peripheral edge 48 of each of the disks 42 is coupled to the primary end 38 corresponding to an associated one of the legs 36. Additionally, each of the first end 32 and the second end 34 of the rod 30 is inserted through the opening 50 in an associated one of the disks 42. Thus, each of the legs 36 is oriented perpendicular to the rod 30. Each of the first 26 and second 28 stabilizers includes a pair of pins 52 and each of the pins 52 is removably extended through the rod 30. Each of the pins 52 is positioned between an associated one of the disks 42 and an associated one of the first and second end 34s of the rod 30. In this way each of the pins 52 inhibits each of the disks 42 from sliding off of the rod 30.

Each of the first 26 and second 28 stabilizers includes a pair of feet 54 and each of the feet 54 has a primary surface 56 and a secondary surface 58. The primary surface 56 is coupled to the secondary end 40 corresponding to an associated one of the legs 36. The legs 36 corresponding to the first stabilizer 26 are oriented to extend downwardly from the ladder 12. Thus, the feet 54 corresponding to the first stabilizer 26 abut the horizontal support surface 18. The legs 36 corresponding to the second stabilizer 28 are oriented to extend forwardly from the ladder 12. Thus, the feet 54 corresponding to the second stabilizer 28 abut the vertical support surface 20.

A pair of pads 60 may be provided and each of the pads 60 may be coupled to the secondary surface 58 corresponding to an associated one of the pads 60. The pads 60 may be comprised of a resiliently compressible material to frictionally engage the horizontal 18 and vertical 20 support surfaces. Additionally, a pair of spikes 62 may be provided and each of the spikes 62 may be coupled to the secondary surface 58 corresponding to an associated one of the pads 60. The spikes 62 may penetrate the horizontal 18 and vertical 20 support surfaces to inhibit the first 26 and second 28 stabilizers from sliding.

In use, the ladder 12 is selectively positioned at an angle between the horizontal support surface 18 and the vertical support surface 20. The rod 30 corresponding to each of the first 26 and second 28 stabilizers is extended through a selected rung 16. Each of the disks 42 corresponding to the first stabilizer 26 is slid onto the rod 30 corresponding to the first stabilizer 26. The pins 52 corresponding to the first stabilizer 26 are inserted through the rod 30 corresponding to the first stabilizer 26. Each of the feet 54 corresponding to the first stabilizer 26 abuts the horizontal support surface 18 to inhibit the ladder 12 from tipping laterally when the ladder 12 is climbed.

Each of the disks 42 corresponding to the second stabilizer 28 is slid onto the rod 30 corresponding to the second stabilizer 28. The pins 52 corresponding to the second stabilizer 28 are inserted through the rod 30 corresponding to the second stabilizer 28. Each of the feet 54 corresponding to the second stabilizer 28 abuts the vertical support surface 20 to inhibit the ladder 12 from bouncing when the ladder 12 is climbed. Each of the first 26 and second 28 stabilizers may be removed from the ladder 12 at any selected time.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A ladder stabilization system comprising:
a ladder having a pair of legs and a plurality of rungs extending between said legs, each of said rungs being substantially hollow, said ladder being configured to be positioned at an angle between a horizontal support surface and a vertical support surface, each of said legs having a bottom end and a top end, said bottom end being configured to abut the horizontal support surface, said top end being configured to abut the vertical support surface;
a first stabilizer being removably coupled to said ladder wherein said first stabilizer is configured to extend between said ladder and the horizontal support surface, said first stabilizer extending downwardly from opposite sides of said ladder wherein said first stabilizer is configured to inhibit said ladder from tipping laterally on the horizontal support surface;
a second stabilizer being removably coupled to said ladder wherein said second stabilizer is configured to extend between said ladder and the vertical support surface, said second stabilizer being horizontally oriented wherein said second stabilizer is configured to inhibit said ladder from bouncing on the vertical support surface when said ladder is climbed;
wherein each of said first stabilizer and said second stabilizer comprises a respective pair of legs, each of said legs of said first stabilizer and said second stabilizer having a primary end and a secondary end, said legs of said second stabilizer being perpendicular to said rungs of said ladder; and
wherein each of said first stabilizer and said second stabilizer comprises a pair of feet, each of said feet having a primary surface and a secondary surface, said primary surface being coupled to said secondary end corresponding to an associated one of said legs of said first stabilizer and said second stabilizer, said secondary surface of said feet of said second stabilizer being perpendicular to said legs of said second stabilizer wherein said feet corresponding to said second stabilizer are configured to abut the vertical support surface.

2. The system according to claim 1, wherein each of said first stabilizer and said second stabilizer comprises a rod having a first end and a second end, said rod being removably inserted through a selected one of said rungs in said ladder having said rod extending outwardly through each of said legs of said ladder, said rod corresponding to said first stabilizer being positioned closer to said bottom end of said ladder than said top end of said ladder, said rod corresponding to said second stabilizer being positioned closer to said top end than said bottom end.

3. (canceled)

4. The system according to claim 1, wherein each of said first stabilizer and said second stabilizer comprises a respective pair of disks, each of said disks having a first surface, a second surface and a peripheral edge extending therebetween, each of said disks having an opening extending through said first surface and said second surface, said peripheral edge of each of said disks being coupled to said primary end corresponding to an associated one of said legs of said first stabilizer and said second stabilizer.

5. The system according to claim 4, wherein each of said first stabilizer and said second stabilizer comprises:
a rod having a first end and a second end; and
each of said first end and said second end of said rod being inserted through said opening in an associated one of said disks, each of said legs of said second stabilizer being oriented perpendicular to said rod of said second stabilizer.

6. The system according to claim 5, wherein each of said first stabilizer and said second stabilizer comprises a pair of pins, each of said pins being removably extended through said rod, each of said pins being positioned between an associated one of said disks and an associated one of said first and second ends of said rod such that each of said pins inhibits each of said disks from sliding off of said rod.

7. (canceled)

8. The system according to claim 1, wherein said pair of legs corresponding to said first stabilizer is oriented to extend downwardly from said ladder wherein said feet corresponding to said first stabilizer are configured to abut the horizontal support surface.

9. The system according to claim 1, wherein said pair of legs corresponding to said second stabilizer is oriented to extend forwardly from said ladder wherein said feet corresponding to said second stabilizer are configured to abut the vertical support surface.

10. A ladder stabilization system comprising:
a ladder having a pair of legs and a plurality of rungs extending between said legs, each of said rungs being substantially hollow, said ladder being configured to be positioned at an angle between a horizontal support surface and a vertical support surface, each of said legs having a bottom end and a top end, said bottom end being configured to abut the horizontal support surface, said top end being configured to abut the vertical support surface;
a first stabilizer being removably coupled to said ladder wherein said first stabilizer is configured to extend between said ladder and the horizontal support surface, said first stabilizer extending downwardly from opposite sides of said ladder wherein said first stabilizer is configured to inhibit said ladder from tipping laterally on the horizontal support surface; and
a second stabilizer being removably coupled to said ladder wherein said second stabilizer is configured to extend between said ladder and the vertical support surface, said second stabilizer being horizontally oriented wherein said second stabilizer is configured to inhibit said ladder from bouncing on the vertical support surface when said ladder is climbed, each of said first stabilizer and said second stabilizer comprising:
a rod having a first end and a second end, said rod being removably inserted through a selected one of said rungs in said ladder having said rod extending outwardly through each of said legs of said ladder, said rod corresponding to said first stabilizer being positioned closer to said bottom end of said ladder than said top end of said ladder, said rod corresponding to said second stabilizer being positioned closer to said top end than said bottom end,
a pair of legs, each of said legs of said first stabilizer and said second stabilizer having a primary end and a secondary end, said legs of said second stabilizer being perpendicular to said rungs of said ladder,
a pair of disks, each of said disks having a first surface, a second surface and a peripheral edge extending therebetween, each of said disks having an opening extending through said first surface and said second surface, said peripheral edge of each of said disks of said first stabilizer and said second stabilizer being coupled to said primary end corresponding to an associated one of said legs of said first stabilizer and said second stabilizer, each of said first end and said second end of said rod being inserted through said opening in an associated one of said disks having each of said legs of said second stabilizer being oriented perpendicular to said rod of said second stabilizer,
a pair of pins, each of said pins being removably extended through said rod, each of said pins being positioned between an associated one of said disks and an associated one of said first and second ends of said rod such that each of said pins inhibits each of said disks from sliding off of said rod,
a pair of feet, each of said feet having a primary surface and a secondary surface, said primary surface being coupled to said secondary end corresponding to an associated one of said legs of said first stabilizer and said second stabilizer, said legs corresponding to said first stabilizer being oriented to extend downwardly from said ladder wherein said feet corresponding to said first stabilizer are configured to abut the horizontal support surface, said legs corresponding to said second stabilizer being oriented to extend forwardly from said ladder wherein said feet corresponding to said second stabilizer are configured to abut the vertical support surface.
